(19) United States
(12) Patent Application Publication
(10) Pub. No.: US 2026/0009289 A1
(43) Pub. Date: Jan. 8, 2026

(54) A WINDOW BLIND HEADRAIL

(71) Applicant: LOUVER-LITE LIMITED, Hyde, Cheshire (GB)

(72) Inventor: Andrew GREENING, Hyde, Cheshire (GB)

(73) Assignee: LOUVER-LITE LIMITED, Hyde, Cheshire (GB)

(21) Appl. No.: 18/993,564

(22) PCT Filed: Jul. 13, 2023
(86) PCT No.: PCT/GB2023/051843

§ 371 Date: Jan. 12, 2025

(30) Foreign Application Priority Data
Jul. 13, 2022 (GB) 2210299.0

(51) Int. Cl. E06B 9/323

(52) U.S. Cl. CPC E06B 9/323

(57) ABSTRACT

A window blind headrail, wherein the headrail includes a headrail body that defines a longitudinal axis; wherein the headrail body includes a front wall; wherein the headrail further includes a pair of end covers, the end covers being slidably coupled to the front wall of the headrail body; wherein the end covers slide axially along the front wall; and wherein each end cover has an extended configuration in which a part of the end cover projects beyond a respective end of the headrail body.

The present invention relates to headrails for window blinds and, in particular to headrails that include sliding end covers that slide axially relative to a headrail body.

It is well known for window blinds to include headrails. Such headrails typically comprise a headrail body that includes a front wall. Conventionally, window blind headrails include cover elements which close each end of the headrail body. In such cases, the cover elements are arranged perpendicular to a longitudinal axis defined by the headrail body. Conventionally, window blind headrails are located within a window recess

However, a gap is usually defined between each end of the headrail body and a respective vertical wall portion of the window recess. Such gaps may be unsightly and are not desired.

The present invention sets out to address one or more of the issues relating to conventional headrails.

According to a first aspect of the invention, there is provided a window blind headrail, wherein the headrail includes a headrail body that defines a longitudinal axis; wherein the headrail body includes a front wall; wherein the headrail further includes a pair of end covers, the end covers being slidably coupled to the front wall of the headrail body; wherein the end covers slide axially relative to (i.e., along) the front wall; and wherein each end cover has an extended configuration in which a part of the end cover projects beyond a respective end of the headrail body.

It will be appreciated that the end covers are disposed adjacent to the forward-facing surface of the front wall. Thus, they are disposed forwards or in front of the front wall.

A window blind headrail according to the invention is able to cover the gaps between the ends of the headrail and the respective walls that define the window rebate area with the slidable end covers. The end covers may be provided with a length (i.e., a dimension parallel to the longitudinal axis of the headrail body) such that gaps up to a pre-determined size may be covered by the end covers. Such an arrangement provides an aesthetically pleasing result, as no gaps between the ends of the headrail and the respective walls that define the window rebate area are visible in use.

In the context of the present invention, the term “headrail” is intended to include all window blind components that house an upper portion of a window blind. Thus, the term “headrail” includes cassette units and roller blind housings. Additionally, it will be understood that the “front wall” of the headrail body is the wall which depends downward and which is typically visible in use. In other words, it is the wall of the headrail which is furthest from a window or other architectural opening.

In an embodiment of the invention, each end cover is arranged such that its cross-sectional shape matches or corresponds to the cross-sectional shape of the headrail. In this way, the end covers visually blend with the front wall of the headrail body. Each of the end covers may also have a height dimension (i.e., a vertical dimension in use) which is substantially equal to a height dimension of the headrail body. In this way, the end covers may appear to be an extension of the headrail body when in their extended configurations.

In certain embodiments of the invention, the front wall of the headrail body is curved and each of the end covers defines a complementary curved surface.

The front wall of the headrail body may include one or more upper engagement portions that extend axially along at least a portion of the front wall; and each of the end covers engages the or a respective one of the upper engagement portions. In such embodiments, the end covers may be slidably coupled at an upper portion thereof to the front wall of the headrail body.

The upper engagement portion may be a single engagement portion that extends the entire length of the front wall of the headrail body. As headrail bodies tend to be extruded components, it may be relatively straightforward to extrude the headrail body with a continuous engagement portion. In such embodiments, the end covers are capable of moving along the entire length of the front wall of the headrail body. Alternatively, it may comprise a first upper engagement portion located at a first end of the front wall and a second upper engagement portion located at a second (opposite) end of the front wall. In such embodiments, each of the end covers is slidably coupled to a respective one of the upper engagement portions. Accordingly, the end covers may be able to slide along the entire length of the headrail body or only along portions of the headrail body.

Suitably, the or each upper engagement portion includes a downwardly projecting skirt and each of the end covers is slidably coupled to the or a respective one of the downwardly projecting skirts. An axial skirt portion permits a slidable engagement for the end covers. For example, each of the end covers may include a skirt coupling portion which slidably engages the or a respective one of the downwardly projecting skirts. In such embodiments, the skirt coupling portion may comprise a substantially U-shaped coupling portion, wherein the skirt may be disposed between the opposed arms of the U-shaped coupling portion.

At least one of the arms of the U-shaped coupling portion may be resiliently deflectable. In such embodiments, the U-shaped coupling portion may form a snap-fit coupling with the downwardly projecting skirt. A snap-fit coupling permits a quick and easy attachment of the end covers to the headrail body.

Additionally or alternatively, the front wall of the headrail body may include one or more lower engagement portions that extend axially along at least a portion of the front wall; and each of the end covers engages the or a respective one of the lower engagement portions. In such embodiments, the end covers may be slidably coupled at a lower portion thereof to the front wall of the headrail body.

As with the upper engagement portion discussed above, the lower engagement portion may be a single engagement portion that extends the entire length of the front wall of the headrail body. Alternatively, it may comprise a first lower engagement portion located at a first end of the front wall and a second lower engagement portion located at a second (opposite) end of the front wall. In such embodiments, each of the end covers is slidably coupled to a respective one of the lower engagement portions.

Suitably, the or each lower engagement portion includes an upwardly projecting rib and each of the end covers is slidably coupled to the or a respective one of the upwardly projecting ribs. For example, each of the end covers may include a rib coupling portion which slidably engages the or a respective one of the upwardly projecting ribs. In such embodiments, the rib coupling portion may include a recess that receives therein a portion of the upwardly projecting rib.

In an embodiment of the invention, the front wall of the headrail body includes both one or more upper engagement portions and one or more lower engagement portions, where the upper and lower engagement portions are as defined hereinabove. In such embodiments, each end cover suitably includes a hook portion that partially surrounds the upper engagement portion or the lower engagement portion of the front wall. Such an arrangement permits each end cover to hinge around either the upper or lower engagement portion of the front wall. This makes it easier to align and to slidably couple the end covers to the front wall of the headrail body.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawing in which:

FIG. 1 shows a perspective view of a headrail including a headrail body and a pair of end covers according to the invention;

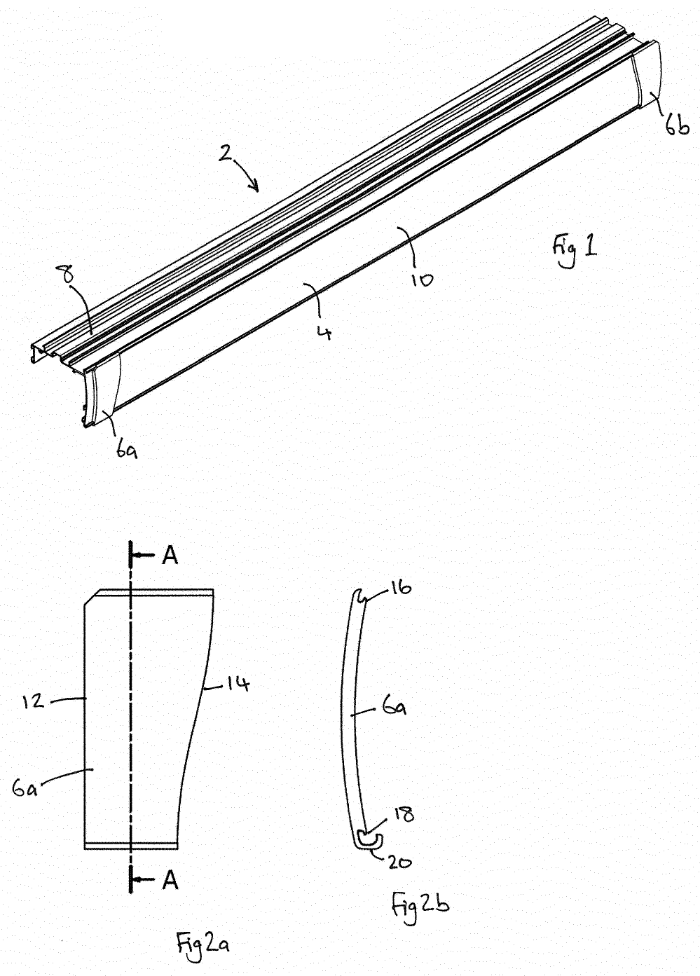

FIGS. 2a and 2b show an end cover in more detail;

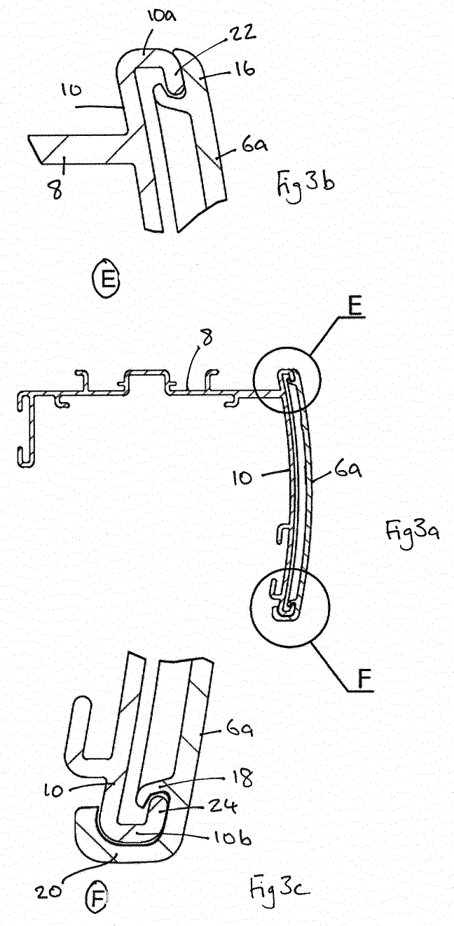

FIGS. 3a to 3c show a cross-sectional view of the attachment of the end cover to the headrail body;

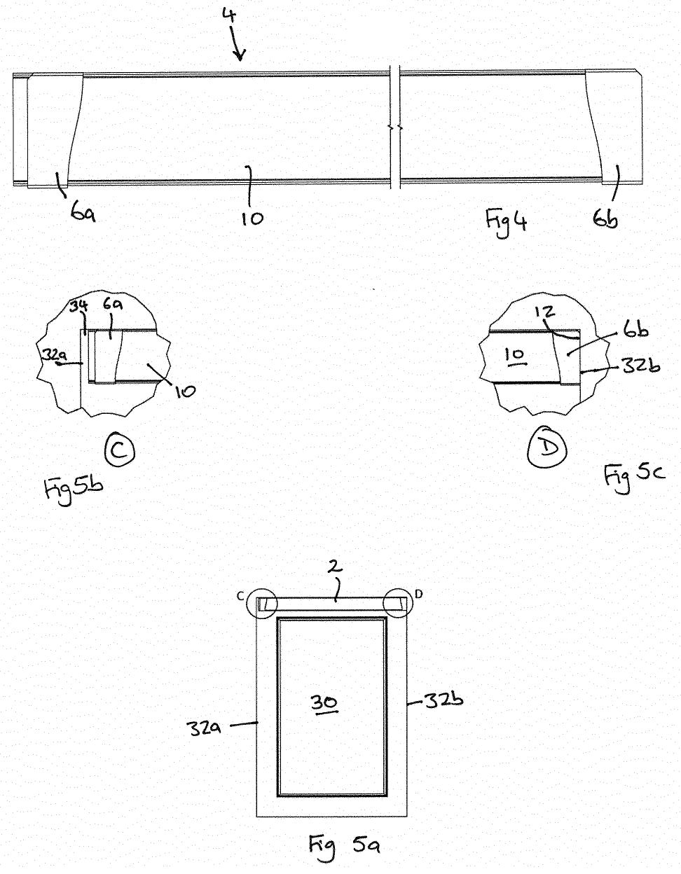

FIG. 4 shows a front elevational view of the headrail shown in FIG. 1 with one of the end covers in a retracted configuration and the other end cover in an extended configuration; and

FIGS. 5a to 5c show the headrail installed within a window recess.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a headrail 2 which includes an extruded headrail body 4 and a pair of end covers 6a, 6b. The headrail body includes a top wall 8 and a front wall 10. The end covers 6a, 6b are slidably coupled to the front wall 10 such that they are capable of sliding axially relative to the front wall 10, where “axially” refers to a direction which is parallel to the longitudinal axis of the headrail body 4.

As shown in FIG. 2a, the end cover 6a includes a straight side 12 and a curved side 14. A cross-section through the axis A-A is shown in FIG. 2b. As can be seen in FIG. 2b, the end cover 6a has a curved profile. At a top edge portion of the end cover 6a, a U-shaped skirt coupling portion 16 is provided. At a bottom edge portion of the end cover 6a, a rib coupling portion 18 is provided. The rib coupling portion 18 is in the form of an inverted U-shaped element. As can be seen in FIG. 2b, one arm 20 of the coupling portion 18 is extended and curves around below the inverted U-shaped element to form a hook.

FIGS. 3a to 3c show the attachment of the end cover 6a to the headrail body 4. As can be seen, the front wall 10 of the headrail body 4 includes a downwardly projecting skirt portion 22 at its top edge 10a. The downwardly projecting skirt portion 22 extends the entire length of the front wall 10. The skirt portion 22 is received between the arms of the U-shaped skirt coupling portion 16 of the end cover 6a.

A bottom edge 10b of the front wall 10 carries a corresponding upwardly projecting rib 24, which is the mirror-image of the skirt portion 22. The upwardly projecting rib 24 is received within the rib coupling portion 18 of the end cover 6a. In addition, the hook element 20 surrounds the bottom edge 10b of the front wall 10.

This arrangement of the hook element 20 and the bottom edge 10b of the front wall 10 permits the bottom of the end cover 6a to hinge around the bottom edge 10b of the front wall 10.

To assemble the headrail 2, the end cover 6a is angled relative to front wall 10 of the headrail body 4 and the hook element 20 is located around the bottom edge of the front wall 10. The end cover 6a is then rotated about the hook element 20 until the U-shaped skirt coupling portion 16 contacts the downwardly projecting skirt 22. The end cover 6a is then urged towards the front wall 10. In doing this, the arm of the U-shaped skirt coupling portion 16 that is closest to the skirt 22 is deflected towards the opposite arm until the skirt 22 is located between the two opposed arms of the U-shaped skirt coupling portion 16. At this point, the deflected arm snaps back into its rest position and resists removal of the skirt 22 from within the coupling portion 16. It is noted that the arm that is deflected when assembling the headrail 2 is shorter than the opposite arm, which facilitates the snap-fit coupling.

With the skirt 22 located within the skirt coupling portion 16 and the upwardly projecting rib is located within the rib coupling portion 18, the end cover 6a is able to slide axially relative to the front wall 10, but resists removal therefrom.

FIG. 4 shows the headrail 2 with the end cover 6a in a retracted configuration in which it entirely overlies a portion of the front wall 10. It also shows the end cover 6b in an extended configuration in which a portion of the end cover 6b extends beyond the end of the front wall 10.

FIGS. 5a to 5c show a headrail 2 disposed within a window recess. The window recess includes a glazed panel 30 set within a recess that includes a pair of opposed side walls 32a, 32b. As can be seen in FIG. 5b, which shows the end cover 6a in a retracted configuration, there is a gap 34 defined between the end of the headrail body 4 and the side wall 32a. A corresponding gap is defined between the opposite end of the headrail body 4 and the side wall 32b.

As shown in FIG. 5c, the gaps 34 are covered by sliding the end covers 6a, 6b into their extended configurations wherein the straight sides 12 contact the respective side wall 32a, 32b. This provides an aesthetically pleasing appearance and protects the components located within the headrail body 4.

1. A window blind headrail, wherein the headrail includes a headrail body that defines a longitudinal axis; wherein the headrail body includes a front wall; wherein the headrail further includes a pair of end covers, the end covers being slidably coupled to the front wall of the headrail body; wherein the end covers slide axially along the front wall; and wherein each end cover has an extended configuration in which a part of the end cover projects beyond a respective end of the headrail body.

2. A window blind headrail according to claim 1, wherein each end cover has a cross-sectional shape which corresponds to the cross-sectional shape of the front wall of the headrail body.

3. A window blind headrail according to claim 1, wherein the front wall of the headrail body is curved and each of the end covers defines a complementary curved surface.

4. A window blind headrail according to claim 1, wherein the front wall of the headrail body includes one or more upper engagement portions that extend axially along at least a portion of the front wall; and each of the end covers engages the or a respective one of the upper engagement portions.

5. A window blind headrail according to claim 4, wherein the front wall includes a single upper engagement portion that extends the entire length of the front wall.

6. A window blind headrail according to claim 4, wherein the upper engagement portion includes a downwardly projecting skirt and each of the end covers is slidably coupled to the or a respective one of the downwardly projecting skirts.

7. A window blind headrail according to claim 6, wherein each of the end covers includes a skirt receiving portion which forms a snap-fit with the or a respective one of the downwardly projecting skirts.

8. A window blind headrail according to Claim 1, wherein the front wall of the headrail body includes one or more lower engagement portions that extends axially along at least a portion of the front wall and each of the end covers engages the or a respective one of the lower engagement portions.

9. A window blind headrail according to claim 8, wherein the front wall includes a single lower engagement portion that extends the entire length of the front wall.

10. A window blind headrail according to claim 8, wherein the or each lower engagement portion includes an upwardly projecting rib and each of the end covers is slidably coupled to the or a respective one of the upwardly projecting ribs.

11. A window blind headrail according to claim 10, wherein each of the end covers includes a rib coupling portion which includes a recess that receives a portion of the or a respective one of the upwardly projecting ribs.
